(19) United States
(12) Patent Application Publication
(10) Pub. No.: US 2024/0154829 A1
(43) Pub. Date: May 9, 2024

(54) DEVICES AND RELATED METHODS FOR PREDICTIVE MEETING ISSUE RESOLUTION

(71) Applicant: Sony Group Corporation, Tokyo (JP)

(72) Inventors: Anders ISBERG, Åkarp (SE); Peter BLOMQVIST, Halmstad (SE); Peter EXNER, Malmö (SE); Hannes BERGKVIST, Rydeback (SE)

(21) Appl. No.: 18/282,523

(22) PCT Filed: Feb. 14, 2022
(86) PCT No.: PCT/EP2022/053541

§ 371 Date: Sep. 16, 2023

(30) Foreign Application Priority Data
Mar. 31, 2021 (SE) 2150405-5

(51) Int. Cl. H04L 12/18

(52) U.S. Cl. CPC H04L 12/1818

(57) ABSTRACT

Disclosed herein are examples of an electronic device comprising processor circuitry, wherein the processor circuitry is configured to obtain meeting data, predict, based on the meeting data and a meeting model, an issue parameter indicative of an issue associated with a meeting, determine, using the meeting model and the issue parameter, an action parameter indicative of an action to address the issue, and provide, based on the action parameter, a resolution output to at least partially resolve the issue.

### TECHNICAL FIELD

The present disclosure pertains generally to the field of device management, such as virtual meeting assistance and more specifically predictive resolution of meeting issues with minimized user input. The present disclosure relates to electronic devices and related methods.

### BACKGROUND

Online, such as virtual, meetings have become an important way of interacting in the current workplace and will likely continue in the future.

While the tools used for online meetings have improved, there are still a significant number of issues that may occur in preparation for the meeting or during the meeting. For example, common issues include audio paths that are not correctly configured because a user typically switches to a new video/audio path during an online meeting, wrong types of cables in the meeting room, a battery being fully drained during the meeting, and issues with network connectivity. These issues can create delays, errors, and unacceptable quality for the meeting and need a resolution in a more efficient manner.

### SUMMARY

Accordingly, there is a need for issue resolution before and during online meetings in a more efficient manner.

There is a need for devices and related methods which may mitigate, alleviate, or address the existing shortcomings, for example by predicting and/or resolving meeting issues without user input and/or minimizing user input.

Disclosed here is an electronic device. The electronic device comprises memory circuitry. The electronic device comprises interface circuitry. The electronic device comprises processor circuitry. The processor circuitry can be configured to obtain meeting data. The processor circuitry is configured to predict, based on the meeting data and a meeting model, an issue parameter indicative of an issue associated with a meeting. The processor circuitry can be configured to determine, using the meeting model and the issue parameter, an action parameter indicative of an action to address the issue. The processor circuitry is configured to provide, based on an action parameter, a resolution output to at least partially resolve the issue.

Disclosed herein is a method. The method is performed by an electronic device. The method can comprise obtaining meeting data. The method comprises predicting, based on the meeting data and a meeting model, an issue parameter indicative of an issue associated with a meeting. The method can comprise determining, using the meeting model and the issue parameter, an action parameter indicative of an action to address the issue. The method comprises providing, based on the action parameter, a resolution output to at least partially resolve the issue.

It is an advantage of the present disclosure to predict potential meeting issues for an upcoming meeting, such as an online meeting. Further, an advantage of the present disclosure includes providing a resolution output to at least partially resolve the meeting issue. This may lead to a proactive issue resolution and assistance to user in carrying out an online meeting, which may reduce the burden on a user to fix the issues before and/or during the meeting. The present disclosure can allow for the avoidance of technical issues occurring during a meeting, thereby improving the experience for all participants.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a block diagram illustrating an example electronic device according to the disclosure,

FIG. 2 is a flow-chart illustrating an example method, performed in an electronic device, and

FIG. 3 is a block diagram illustrating an example electronic device according to the disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

Disclosed herein are devices, systems, assemblies, and/or methods for predicting meeting issues and/or providing an output to at least partially resolve the issues. Many meeting issues can be predicted and proactively fixed without, or with minimized, user input, thereby reducing burdens on the user.

The meetings discussed herein can be online and/or virtual meetings, such as via videoconferencing or teleconferencing. The meetings discussed herein can be audio meetings. The meetings discussed herein can be in-person meetings. The meetings discussed herein can be meetings including a technical component. The meetings can be, for example, conferences, presentations, gatherings, assemblies, conventions, summits, forums, interviews, committees, groups, social activities, and the particular type of meeting is not limiting.

Electronic devices and methods disclosed herein can utilize a meeting model, such as an agent, a meeting agent, and/or a cognitive meeting agent. The meeting model can be configured to predict issues associated with a meeting, for example potential issues, such as from meeting data, and provide an output before and/or during the meeting to resolve the issues, such as through the execution of an action. After the meeting, the meeting model can be configured to be set and/or trained and/or updated to learn from the meeting data and output, along with the actual behaviour of the users and/or participants in the meeting, thereby improving future meetings.

Training as discussed herein can include one or more of: updating, adding data, machine learning, artificial intelligence learning, adding labeling data, adding annotating data, and modifying, such as for the meeting model. Training can include updating. Training can include adding data, such as to the meeting model. Training can include machine learning, such as by the meeting model. Training can include artificial intelligence learning, such as by the meeting model. Training can include modifying data, such as in the meeting model. Training can include adding labeling data and/or meeting data, such as in the meeting model.

The processor circuitry 302 described herein may apply artificial intelligence and/or be trained using learning methods such as supervised or unsupervised machine learning, and the machine learning program can employ a neural network. The processor circuitry 302 described herein may apply artificial intelligence and/or be trained using learning methods such as supervised and/or unsupervised machine learning, such as by using a hybrid learning approach. The processor circuitry 302 described herein may apply artificial intelligence and/or be trained using other learning methods, such as reinforcement learning. The neural network may be one or more of: a convolutional neural network, a deep learning neural network, and a combined learning module or program. Machine learning may be seen as identifying and/or recognizing patterns in existing data (such as meeting data, input data, and/or device data) in order to facilitate making predictions for subsequent data, such as issue parameter, and/or resolution output. Models may be created based on example inputs in order to make valid and reliable predictions for novel inputs and/or outputs. Additionally or alternatively, the meeting model and related machine learning programs may be trained by inputting sample data sets or certain data into the programs, such as input data, meeting data, device data, and/or numerical analysis thereof. The meeting model may utilize deep learning algorithms that may be primarily focused on pattern recognition, and may be trained after processing multiple examples. The meeting model and associated program may include Bayesian program learning (BPL), voice recognition and synthesis, image or object recognition, optical character recognition, and/or natural language processing The meeting model may utilize natural language processing, semantic analysis, and/or automatic reasoning.

In supervised machine learning, the processor circuitry 302 described herein may be provided with example inputs and their associated outputs, and may seek to discover a general rule that maps inputs to outputs, so that when subsequent novel inputs are provided the processor circuitry 302 may, based upon the discovered rule, accurately predict the correct output. In unsupervised machine learning, the processor circuitry 302 may be required to find its own structure in unlabeled example inputs. In one or more examples, machine learning techniques may be used to extract data from input data set, such as meeting data set, and/or other data sets. Based on these analyses, the processing element may learn how to identify characteristics and patterns (such as meeting pattern(s) and/or device pattern(s)) that may then be applied to training the meeting models, and predicting the issue parameter disclosed herein. In one or more examples, the processor circuitry 302 may be configured to combine a supervised machine learning and an unsupervised machine learning in a hybrid learning technique.

For example, the electronic devices and methods disclosed herein can be configured to provide outputs to resolve issues, such as to schedule the meetings, such as by having close integration with some calendar function. The devices and methods disclosed herein can be configured to determine a feasible time slot, determine a meeting location with enough seats, and determine correct equipment. When it is time for meeting, the devices and methods disclosed herein can be configured to provide an output in the form of notification that the meeting is about to start, and provide an output in the form of directions to the meeting room, for example by using an indoor positioning system. The devices and methods disclosed herein can be configured to perform further steps and outputs as will be discussed.

The electronic device disclosed herein can be one of many types of electronic devices, for example one or more of: a user device, a conference device, a computer, a tablet, a server and a smart phone. The electronic device can be a user device. The electronic device may be a conference device. The electronic device can be computer. The electronic device may be a tablet. The electronic device may be an application. The electronic device may be a smart phone. The electronic device can be a device running a program. For example, the electronic device can be a phone running an application.

The electronic device disclosed herein may be a server. The electronic device disclosed herein may be a physical server. The electronic device disclosed herein may be a virtual server. The electronic device disclosed herein may be a cloud server.

The electronic device can be part of a system and/or assembly of devices. The electronic device can be one or more electronic devices. The electronic device can be configured to connect to one or more other electronic devices. The electronic device can be configured to connect to a server. The electronic device can be configured to connect to an image sensor. The electronic device can be configured to connect to a user equipment. The electronic device can be configured to connect via wired and/or wireless connections. The connections can be wired and/or wireless connections.

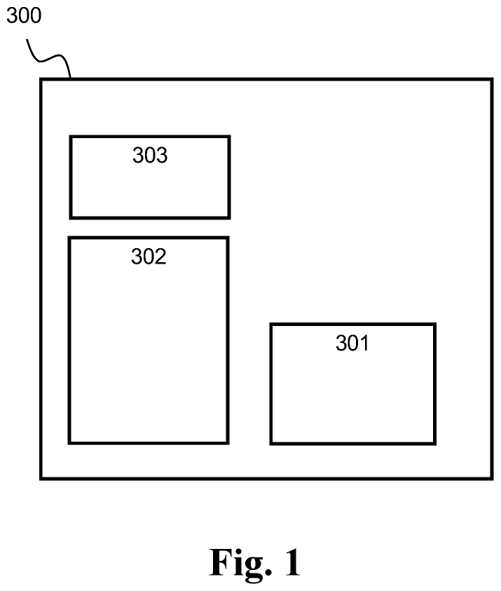

FIG. 1 shows a block diagram of an example electronic device 300 according to the disclosure.

The electronic device 300 comprises memory circuitry 301. The electronic device 300 comprises processor circuitry 302. The electronic device 300 comprises interface circuitry 303, for example for wired and/or wireless communications.

In one or more example electronic devices, the electronic device 300 comprises memory circuitry 301. In one or more example electronic devices, the electronic device 300 comprises interface circuitry 303. In one or more example electronic devices, the electronic device 300 comprises processor circuitry 302. In one or more example electronic devices, the processor circuitry 302 can be configured to obtain meeting data. In one or more example electronic devices, the processor circuitry 302 is configured to predict, based on the meeting data and a meeting model, an issue parameter indicative of an issue associated with a meeting. In one or more example electronic devices, the processor circuitry 302 is configured to predict an issue parameter. In one or more example electronic devices, the issue parameter can be indicative of an issue associated with a meeting. In one or more example electronic devices, the processor circuitry 302 can be configured to determine, using the meeting model and the issue parameter, an action parameter indicative of an action to address the issue. In one or more example electronic devices, the processor circuitry 302 can be configured to determine an action parameter. In one or more example electronic devices, the action parameter can be indicative of an action to address the issue. In one or more example electronic devices, the processor circuitry 302 is configured to provide, based on the action parameter, a resolution output to at least partially resolve the issue. In one or more example electronic devices, the processor circuitry 302 is configured to provide a resolution output. In one or more example electronic devices, the resolution output can at least partially resolve the issue.

The processor circuitry 302 can be configured to obtain (such as receive, request, and/or retrieve) meeting data, for example from the memory circuitry 301, from an external device, and/or from a database. The meeting data may be seen as data representative and/or indicative of a meeting. The meeting may be representative and/or indicative of an aspect of a meeting. The meeting data may be representative and/or indicative of requirements of the meeting. The meeting data may be representative and/or indicative of technological requirements of the meeting. The meeting data may be representative and/or indicative of physical requirements of the meeting. The meeting data may be representative and/or indicative of timing of the meeting. The meeting data may be representative and/or indicative of specifics of the meeting. The meeting data may be representative and/or indicative of location(s) of the meeting. The meeting data may be representative and/or indicative of setup requirements of the meeting. The meeting data may be representative and/or indicative of meeting attendees and/or devices associate with the meeting attendees. The meeting data may be representative and/or indicative of a second meeting after the meeting.

The meeting data may include input data. The meeting data may be representative and/or indicative of configuration requirements of the meeting. The meeting data may include data internal to the electronic device 300. The meeting data may include data external to the electronic device 300. For example, the meeting data may comprise one or more of: input data, data associated with requirements of the meeting, data associated with physical requirements of the meeting, data associated with timing of the meeting, specifics of the meeting, and data associated with location(s) of the meeting.

The processor circuitry 302 can be configured to obtain meeting data prior to the meeting. The processor circuitry 302 can be configured to obtain meeting data during the meeting. The processor circuitry 302 can be configured to obtain meeting data in real-time. The processor circuitry 302 can be configured to obtain meeting data after the meeting. The processor circuitry 302 can be configured to obtain meeting data one or more of: prior to the meeting, during the meeting, in real-time, and after the meeting.

In one or more example electronic devices, the electronic device 300 can be configured to obtain the meeting data via one or more of: a sensor, a local device manager, and an external service. In one or more example electronic devices, the electronic device 300 can be configured to obtain the meeting data via a sensor. In one or more example electronic devices, the electronic device 300 can be configured to obtain the meeting data via a local device manager. In one or more example electronic devices, the electronic device 300 can be configured to obtain the meeting data via an external service.

The electronic device 300 can be configured to retrieve the meeting data. For example, the electronic device 300 can be configured to retrieve the meeting data from memory circuitry 301, and/or from an application configured to run on the electronic device (such as a calendar application, a communication application, an email application, a chat application, a conferencing application and/or a document processing application). The electronic device 300 can be configured to receive the meeting data, for example via the interface 303. The electronic device 300 can be configured to one or more of: receive the meeting data, obtain the meeting data, and retrieve the meeting data.

The electronic device 300 can be configured to obtain meeting data from a sensor. The sensor can be one or more of: an optical sensor, an image sensor, a location sensor, and a connectivity sensor. The electronic device 300 can be configured to obtain meeting data from a local device manager, such as a local device program and/or application. The local device manager may be included in the electronic device 300. The electronic device 300 can be configured to obtain meeting data from an external service, such as via interface circuitry 303, from one or more of: a physical server, a cloud server, a user device, a conference device, and another electronic device. In one or more example electronic devices, the electronic device 300 is configured to obtain the meeting data via one or more of: a server, a computer, a user device, a tablet, a smart phone, a conference meeting device, data indicative of physical changes, real-world data representative of the real world, received data, an application, and a program.

In one or more example electronic devices, the obtaining of the meeting data is based on one or more of: a calendar meeting, a disconnection of a user device from a docking station, a motion of a user, historical regular meeting information, a connection of a new media device to a user device, and a start of a meeting application. In one or more example electronic devices, the obtaining of the meeting data is based on a calendar meeting. In one or more example electronic devices, the obtaining of the meeting data is based on a disconnection of a user device from a docking station. In one or more example electronic devices, the obtaining of the meeting data is based on a motion of a user. In one or more example electronic devices, the obtaining of the meeting data is based on historical regular meeting information. In one or more example electronic devices, the obtaining of the meeting data is based on a connection of a new media device to a user device. In one or more example electronic devices, the obtaining of the meeting data is based on a start of a meeting application.

For example, the electronic device 300 may be configured to obtain meeting data under certain conditions being satisfied. The electronic device 300 may be configured to activate, such as start, the meeting model upon certain conditions being met. The electronic device 300 may be continuously obtaining meeting data.

For example, the obtaining meeting data may be based on data indicative of an upcoming meeting stored on the electronic device 300, for example indicating that an upcoming meeting is planned. This can be, for example, a calendar reminder. In one or more example electronic devices, the condition to begin obtaining meeting data and/or activate the meeting model may be the determination that the processor circuitry 302 detects, identifies, and/or retrieves data indicative of a meeting.

The obtaining meeting data may be based on data indicating that the electronic device 300 has been connected to a media device, such as a headset, a conference device, and/or a projector. In one or more example electronic devices, the condition to begin obtaining meeting data and/or activate the meeting model may be the determination, by the electronic device 300 that a media device is connected.

The obtaining meeting data may be based on data indicating that the electronic device 300, such as a user device, has been disconnected from a docking station. The obtaining meeting data may be based on motion of a user of the electronic device 300, such as through location data, and/or such as via sensor data. Both instances may be indicative of a user travelling to another room for a meeting. In one or more example electronic devices, the condition to begin obtaining meeting data and/or activate the meeting model may be the determination that the electronic device 300 has been disconnected from a docking station and/or moved.

In one or more example electronic devices, the processor circuitry 302 can be configured to predict an issue parameter indicative of an issue associated with a meeting. The issue parameter can be based on the meeting data and a meeting model. The issue may be a technical issue. The issue may be a hardware issue. The issue may be a network issue. The issue may be a software issue. The issue may be one or more of: a technical issue, a hardware issue, a network issue, and a software issue.

The processor circuitry 302 can be configured to predict an issue parameter based on user input. For example, the user input can be indicative of an amount of time before a meeting. The processor circuitry 302 can be configured to begin predicting an issue parameter based on the user input indicative of an amount of time before a meeting. The processor circuitry 302 can be configured to predict an issue parameter at a pre-set time before a meeting. In one or more example server devices, the processor circuitry 302 can be configured to predict an issue parameter 5, 10, 15, 20, 30, or 60 minutes before a meeting.

The issue parameter may be indicative of a potential issue. The issue parameter may be indicative of a probable issue. The issue parameter may be indicative of an issue that is not occurring at the time that the issue parameter has been predicted.

In one or more example electronic devices, the meeting model may include machine learning. In one or more example electronic devices, the meeting model may include artificial intelligence. The machine learning may be a machine learning scheme. The artificial intelligence may be an artificial intelligence scheme.

In one or more example electronic devices, the meeting model can comprise a regression model. The meeting model can be a neural network (NN) regression model (such as a feed forward neural network). The regression model can be a random forest (RF) regression model. The meeting model can be configured to perform regression analysis.

The meeting model can use a set of statistical processes for estimating a relationship between a dependent variable and one or more independent variables. The meeting model can be configured to perform a linear regression.

In one or more example electronic devices, the input to the meeting model, such as a feed forward neural network model or a random forest model, can be vectors of independent variables. One or more of the input, such as independent, variables can be dependent on another input, such as independent, variable in some instances. One or more of the independent variables can be fully independent from another independent variable in some instances. In one or more example electronic devices, multicollinearity can be dealt with for the independent variables prior to being input into the meeting model. With the dependent variable given, training can be performed by backward propagation and ensemble methods for NN models and RF models, respectively.

As an example, the meeting model can be configured to be trained to predict laptop battery duration during a meeting. The independent variables may comprise meeting time of day and/or meeting location, as lighting conditions can affect monitor brightness. The independent variables may comprise a variable indicative of meeting format (such as offline, chat, video), a variable indicative of expected user activity (such as presenting and/or passive listening). Other independent variables can be used as well. The independent variables can comprise one or more of: meeting time, meeting location, meeting format, and expected user activity.

In one or more example electronic devices, the dependent variable can comprise duration, such as time. For example, the dependent variable can be 1600 seconds. A mathematical expression for a simple linear regression may be a linear combination of the following: an intercept, the weighted independent variables, and gaussian noise.

In one or more example electronic devices, the meeting model can be based on one or more of: a set of rule parameters, one or more device patterns, and one or more meeting patterns.

The set of rule parameters can be indicative of one or more rules, that may be used to determine one or more actions. For example, the meeting model can be configured to take a particular action when the meeting model has determined that a rule has been met.

The one or more device patterns may be seen as one or more patterns exhibited by a device, such as the electronic device 300 or another device, over time, for example based on observations of the device performances, activities, and/or processing. The one or more meeting patterns may be seen as one or more patterns over time exhibited by meetings, such as times and/or dates of a meeting, lengths of a meeting, and requirements of a meeting. The meeting model may be used to determine and apply one or more patterns, such as one or more device patterns, and one or more meeting patterns.

The one or more device patterns can be indicative of a device behavior, such as behavior of the electronic device 300, such as a user device. For example, the one or more device patterns can be one or more of: movement of the electronic device 300, usage of the electronic device 300, frequently used programs of the electronic device 300, and power usage of the electronic device 300. The one or more device patterns may be based on hardware behavior of the electronic device 300, such as battery behavior, peripherals behaviors (such as if a user tends to join meetings using headsets and/or headphones), sensor behavior (such as cameras, microphones), and/or connector behavior.

The one or more meeting patterns can be indicative of a user's behavior, such as presenting, speaking, and video usage, during a meeting. The one or more meeting patterns can be indicative of one or more of: duration of video usage, duration of speaking by the user, frequency of speaking by the user, programs used by the user, and accessory technology used by the user.

In one or more exemplary electronic devices, the one or more device patterns and the one or more meeting patterns can be linked, such as associated. For example, the type of meeting equipment usage (device pattern) may be dependent on who the meeting is with and/or the number of participants and/or the respective meeting location(s) (meeting pattern). For example, if meeting room has been selected and another participant has also selected that same meeting room (meeting pattern), it is unlikely that a headset will be required (device pattern).

In one or more example electronic devices, the meeting model can comprise a set of pre-trained rule parameters. The set of pre-trained rule parameters can be stored in the meeting model prior to any training of the meeting model. The set of pre-trained rule parameters can be indicative of one or more issue parameters and one or more action parameters. The set of pre-trained rule parameters can be indicative of one or more issue parameters each associated with one or more action parameters. The set of pre-trained rule parameters can be updated.

In one or more example electronic devices, the meeting model can comprise a database. The database can be stored in the meeting model prior to any training of the meeting model. The database can include a set of pre-trained rule parameters. The database can include one or more issue parameters and one or more action parameters. The database can include issue parameters each associated with one or more action parameters. The database can be updated. For example, one or more parameters, such as issue parameters, action parameters, and pre-trained rule parameters, stored in the database can be updated.

In one or more example electronic devices, the meeting model can include one or more of: a set of rule parameters, one or more device patterns, one or more meeting patterns, a regression model, a set of pre-trained rule parameters, and a database.

In one or more example electronic devices, the meeting model can comprise a plurality of user profiles. For example, the meeting model can have a first user profile, a second user profile, and a third user profile. The number of user profiles is not limiting.

Each user profile may have one or more issue parameters and one or more action parameters. The one or more issue parameters may be the same for each user profile. The one or more issue parameters may be different for each user profile. Some of the one or more issue parameters may be the same and some of the one or more issue parameters may be different for each user profile. The one or more action parameters may be the same for each user profile. The one or more action parameters may be different for each user profile. Some of the one or more action parameters may be the same and some of the one or more action parameters may be different for each user profile.

In one or more example electronic devices, multiple users can use the electronic device 300. Each user can have a user profile. Each user can modify their user profile as desired to provide an optimized performance for that particular user.

Predicting as discussed herein can include predicting issues that have not yet happened, such as identifying and/or determining issues that are imminent but in the near future. In one or more example electronic devices, the predicting can include issues currently happening. Predicting can be performed by statistical processing or statistical analysis, for example regression analysis. Predicting as discussed herein can be forecasting.

The predicting can include obtaining a prediction parameter. The prediction parameter could be indicative of the potential for an issue to occur. The processor circuitry 302 may be configured to obtain and/or determine and/or generate a prediction parameter.

The processor circuitry 302 can be configured to compare the prediction parameter to a prediction threshold. The prediction threshold may be, for example, the percent likelihood of an issue occurring. For example, the prediction threshold may be 50%, meaning that there is a 50% chance of an issue occurring.

The processor circuitry 302 can be configured to determine whether a prediction parameter is above a prediction threshold. The processor circuitry 302 can be configured to determine whether a prediction parameter is not above a prediction threshold.

The processor circuitry 302 can be configured to predict, such as generate and/or obtain, an issue parameter in accordance with the prediction parameter being above the prediction threshold. The processor circuitry 302 can be configured to not predict, such as not generate and/or not obtain, an issue parameter in accordance with the prediction parameter not being above the prediction threshold.

The issue parameter can be seen as a parameter indicative of an issue associated with a meeting. The issue may be internal to the electronic device 300. The issue may be external to the electronic device 300. The issue may be related to the user. The issue may be related to one or more of: a hardware, and/or a software of the electronic device, such as configurations thereof. As examples, an issue can be one or more of: a battery of the electronic device 300 likely running out during a meeting, the electronic device 300 not having a compatible audio configuration for the meeting, the electronic device 300 not having a compatible video configuration for the meeting, the electronic device 300 not being connected to a network for the meeting, and the electronic device 300 not having a compatible network configuration for the meeting.

In one or more example electronic devices, the processor circuitry 302 can be configured to determine an action parameter indicative of an action to address the issue. In one or more example electronic devices, the processor circuitry 302 can be configured to determine, using the meeting model and the issue parameter, an action parameter indicative of an action to address the issue. In one or more example electronic devices, the processor circuitry 302 can be configured to determine, using the meeting model, an action parameter indicative of an action to address the issue. In one or more example electronic devices, the processor circuitry 302 can be configured to determine, using the issue parameter, an action parameter indicative of an action to address the issue.

In one or more example electronic devices, each issue parameter can be associated with one or more action parameters. In one or more example electronic devices, each issue parameter can be associated with one action parameter. In one or more example electronic devices, each issue parameter can be associated with a plurality of action parameters. Multiple issue parameters may be associated with the same action parameter.

In one or more example electronic devices, the issue parameter can be based on meeting data.

For example, the meeting data can be received and/or obtained from a local device manager. The meeting data can be received and/or obtained from a sensor, such as a local sensor. The meeting data can be received and/or obtained from an external device and/or service. The meeting data can be received and/or obtained from one or more of: a local device manager, a sensor, and an external device and/or service.

In one or more examples, the electronic device comprises a sensor. In one or more examples, the electronic device comprises a local device manager. In one or more examples, the sensor is external to the electronic device.

The meeting data can be indicative of different properties and/or statuses and/or configurations of the electronic device 300, such as internal meeting data. For example, meeting data can include one or more of: battery status, such as charging level, audio device, configuration, video device configuration, network configuration, location information, activity recognition data, and calendar data.

The meeting data can be indicative of different properties and/or statuses and/or configurations outside of the electronic device 300, such as external meeting data. For example, meeting data can include one or more of: a wireless network available and an available external device.

In one or more example electronic devices, the action parameter can be indicative of one or more of: a hardware configuration, a network configuration, and/or a software configuration. In one or more example electronic devices, the action parameter can be indicative a hardware configuration. In one or more example electronic devices, the action parameter can be indicative a network configuration. In one or more example electronic devices, the action parameter can be indicative a software configuration.

The hardware configuration may be the hardware configuration of the electronic device 300 (such as a power saving mode of a circuitry of the electronic device). The network configuration may be the network configuration of the electronic device 300 (such as communication or connectors configuration). The software configuration may be the software configuration of the electronic device 300 (such as an audio and/or video configuration). The hardware configuration may be the hardware configuration of an external device configured to connect to the electronic device 300. The network configuration may be the network configuration of an external device. The software configuration may be the software configuration of an external device. The hardware configuration may be the hardware configuration of a user device. The network configuration may be the network configuration of a user device. The software configuration may be the software configuration of a user device.

The action parameter may be indicative of a change of a parameter of one or more of: a hardware configuration, a software configuration, and a network configuration. The action parameter may be indicative of a change of a parameter of one or more of: a hardware configuration, a software configuration, and a network configuration of the electronic device 300.

The action parameter can be seen as a parameter indicative of an action to address the issue. For example, an action can be configured to set one or more parameters of one or more of: a hardware configuration, a software configuration, and a network configuration of the electronic device 300. For example, an action can be one or more of: a connecting to a power source, a reduction of power levels, an opening of a program, a testing of network bandwidth, a changing and/or reconfiguring an audio configuration, a changing and/or reconfiguring a video configuration, and a changing and/or reconfiguring a network configuration.

For example, if the issue is that the electronic device 300 has an incompatible network configuration as it is currently connected to a virtual private network (VPN). The issue parameter may be indicative that the electronic device 300 has an incompatible network configuration as it is currently connected to a VPN. The processor circuitry 302 can be configured to determine an action parameter associated with the issue parameter. The action parameter may be indicative of an action to address the issue, an action such as a change in a network configuration, for example disconnecting from the VPN. Further, the processor circuitry 302 can be configured to output a notification, such as a popup window, regarding the VPN.

In one or more example electronic devices, the processor circuitry 302 can be configured to provide a resolution output to at least partially resolve the issue. In one or more exemplary electronic devices, the processor circuitry 302 can be configured to provide, based on the action parameter, a resolution output to at least partially resolve the issue. The processor circuitry 302 can be configured to provide a resolution output to fully resolve the issue. The processor circuitry 302 can be configured to provide a resolution output internal of the electronic device 300, such as an internal output resolution, and/or provide a resolution output external of the electronic device, such as an external output resolution.

The electronic device 300 can be configured to use the resolution output to partially or fully resolve the issue. The resolution output can be indicative of a parameter change to be made, such as a parameter change of one or more of a: hardware configuration, software configuration, and network configuration. The resolution output can be a signal.

The resolution output can be data. The resolution output can be code. The resolution output can be instructions. The resolution output can be one or more of: a signal, data, code, and instructions.

In one or more example electronic devices, the processor circuitry 302 can be configured to, based on the resolution output, resolve the issue. The processor circuitry 302 can be configured to resolve the issue. The processor circuitry 302 can be configured to resolve the issue before the issue occurs. The processor circuitry 302 can be configured to resolve the issue while the issue is occurring. In one or more example electronic devices, the processor circuitry 302 can be configured to, based on the resolution output, resolve the issue in real-time. For example, the processor circuitry 302 may be configured to change a parameter, such as parameter change of one or more of a: hardware configuration, software configuration, and network configuration.

In one or more example electronic devices, the processor circuitry 302 can be configured to control, based on the resolution output, one or more of: a hardware configuration, a network configuration, and a software configuration, to at least partially resolve the issue. In one or more example electronic devices, the processor circuitry 302 can be configured to control, based on the resolution output, a hardware configuration. In one or more example electronic devices, the processor circuitry 302 can be configured to control, based on the resolution output, a network configuration. In one or more example electronic devices, the processor circuitry 302 can be configured to control, based on the resolution output, a software configuration.

In one or more examples, the processor circuitry 302 may be configured to not control, based on the resolution output, one or more of: a hardware configuration, a network configuration, and a software configuration, to at least partially resolve the issue. In one or more example electronic devices, the processor circuitry 302 can be configured to not control, based on the resolution output, a hardware configuration. In one or more example electronic devices, the processor circuitry 302 can be configured to not control, based on the resolution output, a network configuration. In one or more example electronic devices, the processor circuitry 302 can be configured to not control, based on the resolution output, a software configuration. For example, the processor circuitry 302 may be configured to provide, such as transmit, the resolution output to a device, such as a user, such as to a user's device and/or via a display viewable by a user. The resolution output can include instructions on how the user can resolve the issue.

For example, the processor circuitry 302 may be configured to control a parameter, such as control a parameter of one or more of a: hardware configuration, software configuration, and network configuration.

For example, the processor circuitry 302 can be configured open a videoconferencing application, such as by controlling a parameter of a software configuration. The processor circuitry 302 can be configured to reduce battery usage levels of the electronic device 300, such as by controlling a parameter of a hardware configuration. The processor circuitry 302 can be configured to connect to a network, such as by controlling a parameter of a network configuration. The processor circuitry 302 can be configured to do one or more of: open a videoconferencing application, connect to a network, and reduce battery usage levels of the electronic device 300. These are merely examples, and any number of configurations can be controlled by the processor circuitry 302.

In one or more example electronic devices, the processor circuitry 302 is configured to, in the obtaining of the meeting data, determine whether a meeting indicator indicates that an upcoming meeting is planned. In one or more example electronic devices, the processor circuitry 302 is configured to, in the obtaining of the meeting data, determine whether there is a meeting indicator that indicates that an upcoming meeting is planned. In one or more example electronic devices, the processor circuitry 302 is configured to, in the obtaining of the meeting data, determine whether there is not a meeting indicator that indicates that an upcoming meeting is planned. In one or more example electronic devices, the processor circuitry 302 can be configured to, in the obtaining of the meeting data, obtain the meeting data for the upcoming meeting in accordance with the meeting indicator indicating that the upcoming meeting is planned. In one or more example electronic devices, the processor circuitry 302 is configured to, in the obtaining of the meeting data, not obtain the meeting data for the upcoming meeting in accordance with the meeting indicator not indicating that the upcoming meeting is planned.

The meeting indicator can be indicative of an upcoming meeting. The meeting indicator can be indicative of an upcoming meeting that is planned. In other words, the meeting indicator may indicate that the processor circuitry 302 has identified, from one or more circuitries and/or software running, data indicating an upcoming meeting. The meeting indicator can be not indicative of an upcoming meeting. The meeting indicator can be not indicative of an upcoming meeting that is planned. The meeting indicator can be updated between being indicative of an upcoming meeting and being not indicative of an upcoming meeting.

The processor circuitry 302 may be configured to obtain a meeting indicator. The processor circuitry 302 may be configured to generate a meeting indicator. The processor circuitry 302 may be configured to receive a meeting indicator. The processor circuitry 302 may be configured to update a meeting indicator.

The processor circuitry 302 may be configured to access a calendar, such as an online calendar and/or a calendar service. The processor circuitry 302 may be configured to determine whether the meeting indicator indicates that an upcoming meeting is planned by determining whether the calendar application and/or other application indicates an upcoming meeting. The processor circuitry 302 may be configured to obtain a meeting indicator indicative of an upcoming meeting in accordance with the upcoming meeting being indicated in the calendar application.

In one or more example electronic devices, the electronic device 300 may not be able to access a calendar. For example, the calendar and/or the electronic device 300 may not be connected to a network. Alternatively, the electronic device 300 may not be configured to access the calendar.

Accordingly, the electronic device 300 may use other means to obtain a meeting indicator. For example, in one or more example electronic devices, a meeting indicator indicative of an upcoming meeting can be obtained in accordance with the processor circuitry 302 determining that the electronic device 300 is disconnected from a component. For example, when the electronic device 300 is disconnected from a docking station and/or a power supply.

In one or more example electronic devices, the electronic device 300 may be configured to determine a location of the electronic device, such as via global positioning system (GPS) data and/or sensor data from a motion sensor. The electronic device 300 may be configured to obtain a meeting indicator indicative of an upcoming meeting in accordance with the processor circuitry 302 determining that the electronic device 300 is moving, such as moving towards a conference room.

In one or more example electronic devices, the electronic device 300 may be configured obtain a meeting indicator indicative of an upcoming meeting based on historical data. For example, the electronic device 300 may be configured to obtain a meeting indicator indicative of an upcoming meeting in accordance with the processor circuitry 302 determining that a meeting has occurred at the same time, or approximately the same time, and the same day of the week a previous two or three times. This is for example an indication of a meeting pattern.

For example, if the electronic device 300 has determined that a meeting has occurred at 14:00 the previous two Mondays, the electronic device 300 may be configured to obtain a meeting indicator indicative of a meeting on the upcoming Monday at 14:00 even if there is no meeting listed in the calendar.

In one or more example electronic devices, the electronic device 300 may be configured obtain a meeting indicator indicative of an upcoming meeting in accordance with the processor circuitry 302 determining that a new media device is connected to the electronic device 300. The new media device may be one or more of: a television, a headset, an external microphone, a conference device, and a screen. The new media device may be a television. The new media device may be a headset. The new media device may be an external microphone. The new media device may be a conference device. The new media device may be a screen. This is for example indicative of one or more device patterns. In one or more example electronic devices, the electronic device 300 may be configured obtain a meeting indicator indicative of an upcoming meeting in accordance with the processor circuitry 302 determining that a new connector is connected to the electronic device 300. The connector may be one or more of: a cable, a video graphics array (VGA) cable, a high-definition multimedia interface (HDMI) cable, and a DisplayPort (DP) cable. The connector may be a cable. The connector may be a video graphics array (VGA) cable. The connector may be a high-definition multimedia interface (HDMI) cable. The connector may be a DisplayPort (DP) cable.

In one or more example electronic devices, the electronic device 300 may be configured obtain a meeting indicator indicative of an upcoming meeting in accordance with the processor circuitry 302 determining that a program, such as an application, is started, such as opened and/or initialized. The program can be a videoconferencing program. The program can be a presentation program. The program can be an online meeting program.

In one or more example electronic devices, the processor circuitry 302 can be configured to obtain the meeting data for the upcoming meeting in accordance with the processor circuitry 302 determining that the meeting indicator indicates that an upcoming meeting is planned. The processor circuitry 302 is configured to obtain the meeting data from one or more of: an external source, an internal source, a server, and the internet. The processor circuitry 302 can be configured to obtain the meeting data from an external source, for example an external electronic device and/or an external application. The processor circuitry 302 can be configured to obtain the meeting data from internal the electronic device 300, such as in an application. The processor circuitry 302 can be configured to obtain the meeting data from a server, such as a cloud sever. The processor circuitry 302 is configured to obtain the meeting data from the internet.

The electronic device 300 can be configured to determine whether the meeting indicator is indicative of an upcoming meeting. The electronic device 300 may be configured to start, such as open and/or wake up, the meeting model in accordance with the determination that the meeting indicator is indicative of an upcoming meeting. The meeting model may be continuously awake and/or open.

In one or more example electronic devices, the processor circuitry 302 can be configured to repeat, until the meeting ends, one or more of: the obtaining of the meeting data, the prediction of the issue parameter, the determination of the action parameter, and the provision of the resolution output. In one or more example electronic devices, the processor circuitry 302 can be configured to repeat, until the meeting ends, the obtaining of the meeting data. In one or more example electronic devices, the processor circuitry 302 can be configured to repeat, until the meeting ends, the prediction of the issue parameter. In one or more example electronic devices, the processor circuitry 302 can be configured to repeat, until the meeting ends, the determination of the action parameter. In one or more example electronic devices, the processor circuitry 302 can be configured to repeat, until the meeting ends, the provision of the resolution output.

In one or more example electronic devices, the processor circuitry 302 can be configured to continuously repeat one or more of the obtaining the meeting data, the predicting the issue parameter, the determining the action parameter, and the providing the resolution output throughout the meeting. In one or more example electronic devices, the processor circuitry 302 can be configured to repeat one or more of the obtaining the meeting data, the predicting the issue parameter, the determining the action parameter, and the providing the resolution output throughout the meeting at scheduled times. In one or more example electronic devices, the processor circuitry 302 can be configured to not repeat one or more of the obtaining the meeting data, the predicting the issue parameter, the determining the action parameter, and the providing the resolution output throughout the meeting.

In one or more example electronic devices, the electronic device 300 can be configured to continuously or intermittently or regularly check for issues and attempt to resolve the issues throughout a meeting. In one or more example electronic devices, the electronic device 300 can be configured to continuously or intermittently or regularly check for issues and notify a user of any issues throughout a meeting.

In one or more example electronic devices, the electronic device 300 can be configured to notify a user of any action parameter and/or resolution output, and/or their respective real world action and/or outcome, to be taken. In some examples, a user may be able to override and/or change the action parameter and/or resolution output. For example, the electronic device 300 can be configured to notify a user that it will switch on Wi-Fi as a resolution output. In one or more examples, the electronic device 300 can be configured to receive user input indicative of proceeding with the resolution output, stopping the resolution output, and/or delay the resolution output.

The electronic device 300 can be configured to determine whether the meeting has ended. The electronic device 300 may be configured to shut down, such as put to sleep, the meeting model in accordance with the determination that the meeting has ended.

For example, the electronic device 300 can be configured to determine whether the meeting indicator is not indicative of an upcoming meeting. The electronic device 300 may be configured to shut down, such as put to sleep, the meeting model in accordance with the determination that the meeting indicator is not indicative of an upcoming meeting.

In one or more example electronic devices, the processor circuitry 302 can be configured to, based on one or more of: the meeting data, the issue parameter, and the resolution output, update the meeting model. In one or more example electronic devices, the processor circuitry 302 can be configured to update the meeting model. In one or more example electronic devices, the processor circuitry 302 can be configured to, based on the meeting data, update the meeting model. In one or more example electronic devices, the processor circuitry 302 can be configured to, based on the issue parameter, update the meeting model. In one or more example electronic devices, the processor circuitry 302 can be configured to, based on the resolution output, update the meeting model.

In one or more example electronic devices, the processor circuitry 302 can be configured to train, such as update, the meeting model can be trained based on parameter(s) or actions that have occurred in the processor circuitry 302. For example, the processor circuitry 302 can be configured to update one or more of: the issue parameter, the action parameter, and the resolution output can be updated. The processor circuitry 302 can be configured to add one or more of: a new issue parameter, a new action parameter, and new resolution output.

The processor circuitry 302 can be configured to update the meeting model from meeting data. For example, the processor circuitry 302 can be configured to update the meeting model by meeting data from a local device manager. The processor circuitry 302 can be configured to update the meeting by meeting data from a sensor, such as a local sensor. The processor circuitry 302 can be configured to update the meeting model by meeting data from an external device and/or service. The processor circuitry 302 can be configured to update the meeting model by meeting data from one or more of: a local device manager, a sensor, and an external device and/or service.

For example, the meeting data can be indicative of the type of meeting, such as a slide presentation, a video presentation, an audio presentation, as well as the program to be used for the meeting itself, such as Zoom, teams, skype, hangout. Further, the meeting data can be indicative of battery usage, such as by the central processing unit. Meeting data can be indicative of user behavior, such as long or short meetings, more or less talking and/or listening, video or audio meetings. Meeting data can be indicative of network connectivity.

In one or more example electronic devices, the processor circuitry 302 can be configured to determine a resolution parameter. In one or more example electronic devices, the processor circuitry 302 can be configured to obtain a resolution parameter. In one or more example electronic devices, the processor circuitry 302 can be configured to generate a resolution parameter. The resolution parameter can be indicative of the resolution output at least partially resolving the issue. The resolution parameter can be indicative of the resolution output fully resolving the issue. The resolution parameter can be indicative of an action for the electronic device 300 to take to at least partially or fully resolve the issue.

In one or more example electronic devices, the processor circuitry 302 can be configured to determine if the resolution parameter is indicative of the resolution output at least partially resolving the issue. In one or more example electronic devices, the processor circuitry 302 can be configured to determine if the resolution parameter is indicative of the resolution output fully resolving the issue.

In one or more example electronic devices, the processor circuitry 302 can be configured to determine if the resolution parameter is indicative of the resolution output not at least partially resolving the issue. In one or more example electronic devices, the processor circuitry 302 can be configured to determine if the resolution parameter is indicative of the resolution output not fully resolving the issue.

The processor circuitry 302 can be configured to update the meeting model in accordance with the resolution parameter being indicative of the resolution output at least partially resolving the issue. The processor circuitry 302 can be configured to update the meeting model in accordance with resolution output not at least partially resolving the issue. The processor circuitry 302 can be configured to update the meeting model in accordance with the resolution parameter being indicative of the resolution output fully resolving the issue. The processor circuitry 302 can be configured to update the meeting model in accordance with the resolution parameter being indicative of the resolution output not fully resolving the issue.

As an example, the resolution output may be indicative of reducing battery usage by 25%, as the issue may be running out of battery during the meeting. In accordance with this reduction resolving the issue, and the resolution parameter being indicative of the resolution output at least partially resolving the issue, the meeting model may be updated.

However, if this battery reduction was not sufficient, and the resolution parameter being indicative of the resolution output not at least partially resolving the issue, the meeting model may be updated to indicate that 25% reduction is not sufficient. Accordingly, for the next meeting the resolution output may be indicative of reducing battery usage by 30%.

Further, the processor circuitry 302 can be configured to obtain meeting data during the meeting. For example, the processor circuitry 302 can be configured to obtain battery levels during the meeting. If the battery level is draining faster than predicted, the processor circuitry 302 may be configured to provide a resolution output to reduce battery usage further.

In one or more example electronic devices, the meeting model can be trained, such as updated, before a meeting. In one or more example electronic devices, the meeting model can be trained, such as updated, during a meeting. In one or more example electronic devices, the meeting model can be trained, such as updated, after a meeting.

In one or more example electronic devices, the electronic device 300 can be a server device. In one or more example electronic devices, the electronic device 300 can be a computer. In one or more example electronic devices, the electronic device 300 can be one or more of: a conferencing device and a user device. In one or more example electronic devices, the electronic device 300 can be a conferencing device. In one or more example electronic devices, the electronic device 300 can be a user device. In one or more example electronic devices, the electronic device 300 can be an application. In one or more example electronic device, the electronic device 300 can be selected from one or more of: a server device, a vehicle, a vehicle dashboard, a conferencing device, a user device, a computer, a tablet, a cell phone, an application, and a program.

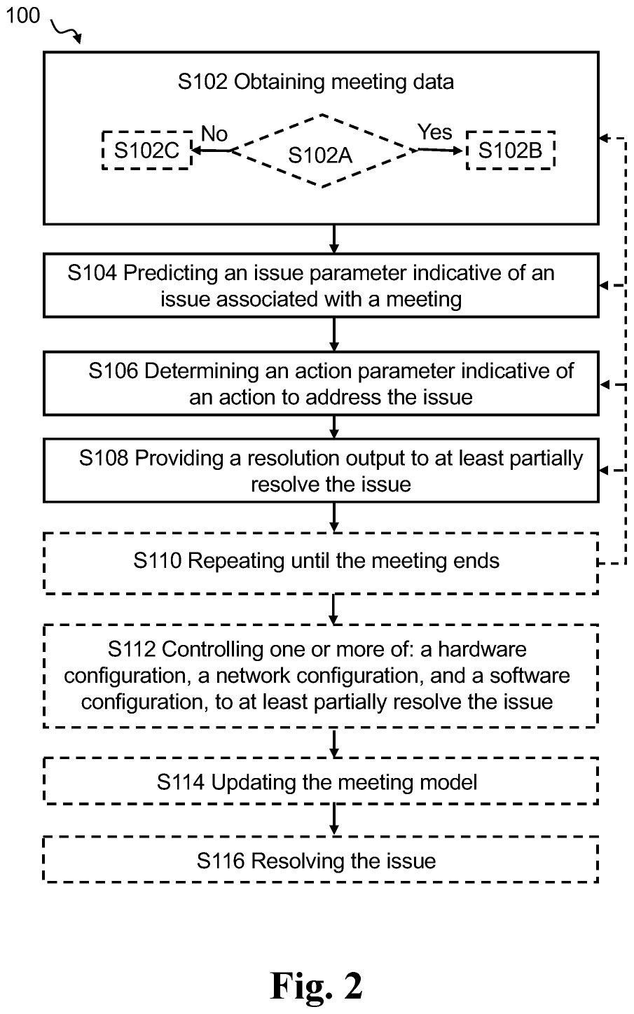

The electronic device 300 is optionally configured to perform any of the operations disclosed in FIG. 2 (such as any one or more of S102, S102A, S102B, S102C, S104, S106, S108, S110, S112, S114, S116). The operations of the electronic device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the electronic device 300 may be considered a method that the electronic device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 1). Memory circuitry 301 is considered a non-transitory computer readable medium.

Memory circuitry 301 may be configured to store information such as one or more of: meeting data, an issue parameter, an action parameter, a resolution output, a set of rule parameters, a set of a pre-trained rule parameters, one or more device patterns, one or more meeting patterns, a meeting indicator, a meeting model in a part of the memory.

FIG. 2 shows a flow diagrams of an example method 100 performed by an electronic device of the disclosure. For example, the electronic device 300 of FIG. 1, or any other electronic device of the disclosure, can perform the method 100.

Disclosed herein are methods. In one or more example methods, the method 100 is performed by an electronic device. The method 100 can comprise obtaining S102 meeting data. The method can comprise predicting S104 an issue parameter indicative of an issue associated with a meeting. The method 100 comprises predicting S104, based on the meeting data and a meeting model, an issue parameter indicative of an issue associated with a meeting. The method 100 can comprise determining S106 an action parameter indicative of an action to address the issue. The method 100 can comprise determining S106, using the meeting model and the issue parameter, an action parameter indicative of an action to address the issue. The method 100 can comprise providing S108 a resolution output to at least partially resolve the issue. The method 100 comprises providing S108, based on the action parameter, a resolution output to at least partially resolve the issue.

In one or more example methods, the meeting model can be based on one or more of: a set of rule parameters, one or more device patterns, and one or more meeting patterns.

In one or more example methods, the obtaining S102 meeting data can comprise determining S102A whether a meeting indicator indicates that an upcoming meeting is planned. In one or more example methods, the obtaining meeting S102 data can comprise S102B obtaining the meeting data for the upcoming meeting in accordance with the meeting indicator indicating that the upcoming meeting is planned. In one or more example methods, the obtaining meeting data can comprise not obtaining S102C the meeting data for the upcoming meeting in accordance with the meeting indicator not indicating that the upcoming meeting is planned.

In one or more example methods, the method 100 can comprise repeating S110, until the meeting ends, one or more of: the obtaining S102 of the meeting data, the predicting S104 of the issue parameter, the determining S106 of the action parameter, and the providing S108 of the resolution output.

In one or more example methods, the method 100 can comprise controlling S112, based on the resolution output, one or more of: a hardware configuration, a network configuration, and a software configuration, to at least partially resolve the issue.

In one or more example methods, the method 100 can comprise, based on at least one of the meeting data, the issue parameter, and the resolution output, updating S114 the meeting model.

In one or more example methods, the method 100 can comprise obtaining the meeting data via one or more of: a sensor, a local device manager, and an external service.

In one or more example methods, the obtaining of the meeting data can be based on one or more of: a calendar meeting, a disconnection of a user device from a docking station, a motion of a user, historical regular meeting information, a connection of a new media device to a user device, and a start of a meeting application.

In one or more example methods, the meeting model can comprise a regression model.

In one or more example methods, the meeting model can comprise a set of pre-trained rule parameters.

In one or more example methods, the action parameter can be indicative of one or more of: a hardware configuration, a network configuration, and/or a software configuration.

In one or more example methods, the meeting model can comprise a database.

In one or more example methods, the method 100 can comprise, based on the resolution output, resolving S116 the issue.

In one or more example methods, the method 100 can comprise resolving S116 the issue in real-time.

In one or more example methods, the meeting model can comprise a plurality of user profiles.

In one or more example methods, the electronic device can be a server device.

In one or more example methods, the electronic device can comprise one or more of: a conferencing device and a user device.

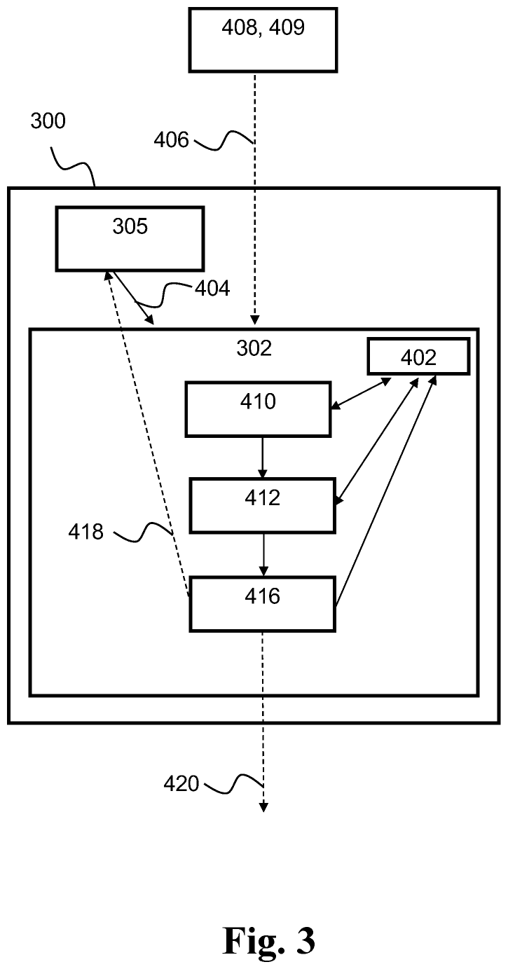

FIG. 3 is a block diagram of an example electronic device of the disclosure, such as electronic device 300. Not all features of FIG. 1 are shown in FIG. 3.

The electronic device 300 including processor circuitry 302 detects an online meeting. For example, a meeting indicator indicates an upcoming meeting. The electronic device 300 can activate the meeting model 402 and monitor any input sources for meeting data. For example, the meeting data may be used by the meeting model for prediction of an issue before it happens. As shown, meeting data may be external meeting data 406 and/or internal meeting data 404. The detection of the online meeting may be via meeting data, such as the external meeting data 406 and/or the internal meeting data 404 (including for example data indicative of one or more of: meeting time, meeting location, and meeting duration).

Internal meeting data 404 can be indicative of, for example, a hardware parameter (such as a battery parameter, such as current battery charge) of the electronic device 300 from a hardware circuitry (such as a battery 305), audio configuration of the electronic device 300, video configuration of the electronic device 300, and network configuration of the electronic device 300. FIG. 3 shows internal meeting data 404 indicative of the current battery charge from battery 305. External meeting data 406 can be indicative of the wireless network that the electronic device 300 may be connected to, and wireless headset connection. FIG. 3 shows external meeting data 406 indicative of a wireless network 408 and a headset 409.

The processor circuitry 302 predicts an issue parameter 410 indicative of an issue associated with the meeting, such as based on the meeting model 402 and the meeting data, such as external meeting data 406 and internal meeting data 404. For example, a plurality of issue parameters 410 can be predictive, such as indicative of, a low battery level of the electronic device 300, the lack of a connected headset, and potential network connectivity issues.

The processor circuitry 302 determines an action parameter 412 indicative of an action to address the issue, such as based on the meeting model 402 and the issue parameter 410. For example, the action parameters 412 may be indicative of reducing the power output of the electronic device, testing network bandwidth, and searching for a wireless headset connection. Further, the action parameters 412 can be indicative of notifying a user that the user should connect the electronic device 300 to a power source and to bring a headset.

The processor circuitry 302 provides a resolution output 416 to at least partially resolve the issue. As shown, the resolution output 416 may be an internal output 418 such as a lowering of the battery usage level, testing bandwidth and optimizing audio and video settings of the electronic device 300 for the network, and connecting to a wireless headset. Thus, the issues may be at least partially resolved by the electronic device 300. Further, the resolution output can an external output 420, such as a notification to a user to plug in the electronic device 300. As the electronic device 300 has connected to a headset, there is no need for a further resolution output notifying the user to connect a headset.

Further, as the resolution output 416 has instructed the electronic device 300 to connect to the headset, the processor circuitry 302 predicts an issue parameter 410 indicative of an issue utilizing the headset. The processor circuitry 302 determines an action parameter 412 indicative of optimizing audio and/or video settings of the headset for the meeting. The processor circuitry 302 provides a resolution output 416, such as an internal resolution output 418, to optimize audio and/or video settings of the headset.

Accordingly, the electronic device 300 predicts and/or at least partially resolve issues without the need for any user input. For issues that the electronic device 300 may not be able to resolve, the resolution output 416 can be an external resolution output 420, such as a notification to a user to take a particular action, thereby simplifying any problems for the user.

The meeting model 402 can be configured to receive the resolution output 416, such as the external resolution output 420 and the internal resolution output 418, in order to train the meeting model 402.

The electronic device 300 can continue to obtain meeting data throughout the meeting until the meeting ends. The electronic device 300 can obtain real-time meeting data, such as mobility and/or modality data (such as by monitoring circuitry during the meeting) and predict new issue parameters 410 based on the real-time meeting data.

Once the meeting has ended, the meeting model 402 may be updated and/or trained based on all data received, used, and output. The meeting model 402 may be updated and/or trained based on one or more of: the meeting data, such as the external meeting data 406 and the internal meeting data 404, the issue parameter 410, the action parameter 412, and the resolution output 416, including internal output 418 and external output 420.

For example, the meeting model 402 can be updated and/or trained based on actual behavior of the user of the electronic device 300. The updating and/or training can be performed on the electronic device 300. The updating and/or training can be performed on a cloud server.

Once the meeting has ended, the electronic device 300 can be configured to stop the meeting model 402, such as by putting it to sleep to sleep, until a new meeting is detected.

Examples of methods and products (electronic devices) according to the disclosure are set out in the following items:

Item 1. An electronic device, the electronic device comprising:
memory circuitry;
interface circuitry; and
processor circuitry, wherein the processor circuitry is configured to:
   obtain meeting data;
   predict, based on the meeting data and a meeting model, an issue parameter indicative of an issue associated with a meeting;
   determine, using the meeting model and the issue parameter, an action parameter indicative of an action to address the issue; and
   provide, based on the action parameter, a resolution output to at least partially resolve the issue.

Item 2. The electronic device of Item 1, wherein the meeting model is based on one or more of: a set of rule parameters, one or more device patterns, and one or more meeting patterns.

Item 3. The electronic device of any one of Items 1-2, wherein the processor circuitry is configured to, in the obtaining of the meeting data:
determine whether a meeting indicator indicates that an upcoming meeting is planned; and
in accordance with the meeting indicator indicating that the upcoming meeting is planned, obtain the meeting data for the upcoming meeting.

Item 4. The electronic device of any one of Items 1-3, wherein the processor circuitry is configured to repeat, until the meeting ends, one or more of: the obtaining of the meeting data, the prediction of the issue parameter, the determination of the action parameter, and the provision of the resolution output.

Item 5. The electronic device of any one of Items 1-4, wherein the processor circuitry is configured to control, based on the resolution output, one or more of: a hardware configuration, a network configuration, and a software configuration, to at least partially resolve the issue.

Item 6. The electronic device of any one of Items 1-5, wherein the processor circuitry is configured to, based on one or more of: the meeting data, the issue parameter, and the resolution output, update the meeting model.

Item 7. The electronic device of any one of Items 1-6, wherein the electronic device is configured to obtain the meeting data via one or more of: a sensor, a local device manager, and an external service.

Item 8. The electronic device of any one of Items 1-7, wherein the obtaining of the meeting data is based on one or more of: a calendar meeting, a disconnection of a user device from a docking station, a motion of a user, historical regular meeting information, a connection of a new media device to a user device, and a start of a meeting application.

Item 9. The electronic device of any one of Items 1-8, wherein the meeting model comprises a regression model.

Item 10. The electronic device of any one of Items 1-9, wherein the meeting model comprises a set of pre-trained rule parameters.

Item 11. The electronic device of any one of Items 1-10, wherein the action parameter is indicative of one or more of: a hardware configuration, a network configuration, and a software configuration.

Item 12. The electronic device of any one of Items 1-11, wherein the meeting model comprises a database.

Item 13. The electronic device of any one of Items 1-12, wherein the processor circuitry is configured to, based on the resolution output, resolve the issue.

Item 14. The electronic device of any one of Items 1-13, wherein the processor circuitry is configured to resolve the issue in real-time.

Item 15. The electronic device of any one of Items 1-14, wherein the meeting model comprises a plurality of user profiles.

Item 16. The electronic device of any one of the previous Items, wherein the electronic device is a server device.

Item 17. The electronic device of any one of Items 1-16, wherein the electronic device comprises one or more of: a conferencing device and a user device.

Item 18. A method, performed by an electronic device, the method comprising:
obtaining S102 meeting data;
predicting S104, based on the meeting data and a meeting model, an issue parameter indicative of an issue associated with a meeting;
determining S106, using the meeting model and the issue parameter, an action parameter indicative of an action to address the issue; and
providing S108, based on the action parameter, a resolution output to at least partially resolve the issue.

Item 19. The method of Item 18, the meeting model is based on one or more of: a set of rule parameters, one or more device patterns, and one or more meeting patterns.

Item 20. The method of any one of Items 18-19, wherein the obtaining S102 meeting data comprises:
determining S102A whether a meeting indicator indicates that an upcoming meeting is planned; and
in accordance with the meeting indicator indicating that the upcoming meeting is planned, obtaining S102B the meeting data for the upcoming meeting.

Item 21. The method of any one of Items 18-20, the method comprising repeating S110, until the meeting ends, one or more of: the obtaining S102 of the meeting data, the predicting S104 of the issue parameter, the determining S106 of the action parameter, and the providing S108 of the resolution output.

Item 22. The method of any one of Items 18-21, the method comprising controlling S112, based on the resolution output, one or more of: a hardware configuration, a network configuration, and a software configuration, to at least partially resolve the issue.

Item 23. The method of any one of Items 18-22, the method comprising, based on at least one of the meeting data, the issue parameter, and the resolution output, updating S114 the meeting model.

Item 24. The method of any one of Items 18-23, the method comprising obtaining S102 the meeting data via one or more of: a sensor, a local device manager, and an external service.

Item 25. The method of any one of Items 18-24, wherein the obtaining S102 of the meeting data is based on one or more of: a calendar meeting, a disconnection of a user device from a docking station, a motion of a user, historical regular meeting information, a connection of a new media device to a user device, and a start of a meeting application.

Item 26. The method of any one of Items 18-25, wherein the meeting model comprises a regression model.

Item 27. The method of any one of Items 18-26, wherein the meeting model comprises a set of pre-trained rule parameters.

Item 28. The method of any one of Items 18-27, wherein the action parameter is indicative of one or more of: a hardware configuration, a network configuration, and/or a software configuration.

Item 29. The method of any one of Items 18-28, wherein the meeting model comprises a database.

Item 30. The method of any one of Items 18-29, the method comprising, based on the resolution output, resolving S116 the issue.

Item 31. The method of any one of Items 18-30, the method comprising, resolving S116 the issue in real-time.

Item 32. The method of any one of Items 18-31, wherein the meeting model comprises a plurality of user profiles.

Item 33. The method of any one of Items 18-32, wherein the electronic device is a server device.

Item 34. The method of any one of Items 18-33, wherein the electronic device comprises one or more of: a conferencing device and a user device.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-3 comprise some circuitries or operations which are illustrated with a solid line and some circuitries or operations which are illustrated with a dashed line. Circuitries or operations which are comprised in a solid line are circuitries or operations which are comprised in the broadest example. Circuitries or operations which are comprised in a dashed line are examples which may be comprised in, or a part of, or are further circuitries or operations which may be taken in addition to circuitries or operations of the solid line examples. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. An electronic device, the electronic device comprising:
memory circuitry;
interface circuitry; and
processor circuitry, wherein the processor circuitry is configured to:
obtain meeting data;
predict, based on the meeting data and a meeting model, an issue parameter indicative of an issue associated with a meeting;
determine, using the meeting model and the issue parameter, an action parameter indicative of an action to address the issue; and
provide, based on the action parameter, a resolution output to at least partially resolve the issue.

2. The electronic device of claim 1, wherein the meeting model is based on one or more of: a set of rule parameters, one or more device patterns, and one or more meeting patterns.

3. The electronic device of claim 1, wherein the processor circuitry is configured to, in the obtaining of the meeting data:
determine whether a meeting indicator indicates that an upcoming meeting is planned; and
in accordance with the meeting indicator indicating that the upcoming meeting is planned, obtain the meeting data for the upcoming meeting.

4. The electronic device of claim 1, wherein the processor circuitry is configured to repeat, until the meeting ends, one or more of: the obtaining of the meeting data, the prediction of the issue parameter, the determination of the action parameter, and the provision of the resolution output.

5. The electronic device of claim 1, wherein the processor circuitry is configured to control, based on the resolution output, one or more of: a hardware configuration, a network configuration, and a software configuration, to at least partially resolve the issue.

6. The electronic device of claim 1, wherein the processor circuitry is configured to, based on one or more of: the meeting data, the issue parameter, and the resolution output, update the meeting model.

7. The electronic device of claim 1, wherein the electronic device is configured to obtain the meeting data via one or more of: a sensor, a local device manager, and an external service.

8. The electronic device of claim 1, wherein the obtaining of the meeting data is based on one or more of: a calendar meeting, a disconnection of a user device from a docking station, a motion of a user, historical regular meeting information, a connection of a new media device to a user device, and a start of a meeting application.

9. The electronic device of claim 1, wherein the meeting model comprises a regression model.

10. The electronic device of claim 1, wherein the meeting model comprises a set of pre-trained rule parameters.

11. The electronic device of claim 1, wherein the action parameter is indicative of one or more of: a hardware configuration, a network configuration, and a software configuration.

12. The electronic device of claim 1, wherein the meeting model comprises a database.

13. The electronic device of claim 1, wherein the processor circuitry is configured to, based on the resolution output, resolve the issue.

14. The electronic device of claim 1, wherein the processor circuitry is configured to resolve the issue in real-time.

15. The electronic device of claim 1, wherein the meeting model comprises a plurality of user profiles.

16. The electronic device of claim 1, wherein the electronic device is a server device.

17. The electronic device of claim 1, wherein the electronic device comprises one or more of: a conferencing device and a user device.

18. A method, performed by an electronic device, the method comprising:
obtaining meeting data;
predicting, based on the meeting data and a meeting model, an issue parameter indicative of an issue associated with a meeting;
determining, using the meeting model and the issue parameter, an action parameter indicative of an action to address the issue; and
providing, based on the action parameter, a resolution output to at least partially resolve the issue.

19. The method of claim 18, wherein the meeting model is based on one or more of: a set of rule parameters, one or more device patterns, and one or more meeting patterns.

20. The method of claim 18, wherein the obtaining S102 meeting data comprises:
determining whether a meeting indicator indicates that an upcoming meeting is planned; and
in accordance with the meeting indicator indicating that the upcoming meeting is planned, obtaining the meeting data for the upcoming meeting.

21-34. (canceled)
